(19) United States
(12) Patent Application Publication
(10) Pub. No.: US 2010/0262552 A1
(43) Pub. Date: Oct. 14, 2010

(54) System and method of global electronic job market in the Internet

(75) Inventor: Valentina Pulnikova, Villingen-Schwenningen (DE)

Correspondence Address: DR. PULNIKOVA VALENTINA, WEIHERSTRASSE 9, VILLINGEN-SCHWENNINGEN, 78050, DE

(73) Assignee: Valentina Pulnikova, Villingen-Schwenningen (DE)

(21) Appl. No.: 12/821,495

(22) Filed: Jun. 23, 2010

Related U.S. Application Data
(63) Continuation of application No. 11/684,622, filed on Mar. 11, 2007, now abandoned.

(51) Int. Cl. G06Q 10/00; G06F 17/30

(52) U.S. Cl. 705/321; 707/790; 707/E17.005

(57) ABSTRACT

A system and a method of global electronic job market in the Internet are provided. The method of operating of a global electronic job market for jobseekers and employers via the Internet includes: registering the jobseekers and the employers; creation of the structured database of offers of employers and a database information about jobseekers on the basis of the International Classification of Specialities and on the basis of the International Classification of Job Position; creation of requests of jobseekers for search of the necessary information in the database of offers of employers; creation of requests of employers for search of the necessary information in the database information about jobseekers; providing of searching of the necessary information according to requests, specified above, in appropriate databases; providing of jobseekers by the list of offers from employers, acceptable for them, which are available in the database; providing of employers by the list of offers from jobseekers, acceptable for them, which are available in the database; a choice of partners in employment out of the presented lists; holding competitions for job vacancies (tenders); conclusion of job contracts between jobseekers and employers; providing additional services of the system of global electronic job market.

### CROSS-REFERENCE TO RELATED APPLICATIONS

This application is continuation of application Ser. No. 11/684,622 filed Mar. 11, 2007 now abandoned.

### FIELD OF INVENTION

This invention relates to the electronic job market and in particular to the global electronic job market in the Internet.

### BACKGROUND OF INVENTION

### 1. Description of the Related Art

At present the Internet has become one of the most popular ways for finding a job. There are many Web sites devoted to the problem of searching for a job, such as www.monster.com, www.jobsearch.co.uk, www.jobsearch.org, www.jobbankusa.com, www.jobserve.com, www.jobpilot.net and others.

Characteristic features of these Web sites are:
a possibility to fulfil search by a jobseeker only in general;
a very poor list of categories of employments;
searching on the basis of key words;
absence of a possibility of sorting search results,
these are mostly the national sites.

### 2. Problems

Analysis of patents and Web sites reveals the following main problems existing in the electronic job market.

The first problem is the absence of any classification of job positions and the absence of any classifications of specialities. A list of job positions on the basis of categories of employments does not allow creating a well-structured database of offers of employers or employees. Eventually, a search for a job on the basis of key words often gives unacceptable results.

Absence of complete structuring of the data does not allow to carry out the fast and qualitative search, a result of which completely satisfies the user.

Another problem is the absence of a possibility to conduct a developed sorting of search results. Therefore, it is very difficult to find a needed result, if the large list of search results.

Another problem is the national rather than the global character of Web sites. It is impossible to get a global result on your request. This is also one of impediments for the global job market.

Another problem is the absence of a developed transaction procedure within the system of the electronic job market, which includes a negotiation procedure and a procedure for concluding job contracts.

Another problem is the absence of a possibility of inserting formal data in a database for highly qualified jobseekers.

For solution of the specified problems, it is necessary to carry out structuring of the information arriving in system of an electronic job market from employers and from employees. First of all, it is necessary to structure the main data of a job market, namely: specialities of employees and their positions. For a global job market it is necessary to create the International Classification of Specialities and the International Classification of Job Positions. Besides, should be structured data including: an education, a work experience, a salary, a work place, knowledge of language etc. The system of an electronic job market should have a database with completely structured information. In the presence of the specified database, users can easily find the demanded information, and also to carry out necessary sorting and selecting.

### SUMMARY OF THE INVENTION

A system and a method of the global electronic job market via the Internet are proposed in this invention.

The system comprises a Web site or another network communication program, located on a host server, communication channels of the Internet and numerous computers of users. The users are jobseekers and employers, who are equitable participants of the process. The method of the operation of the global electronic job market includes a registration block, an information block, a block of search and selection of a partner on the job market, a block of competitions for job vacancies, a transaction block and a block of additional services of the system of the global job market.

After registration, jobseekers and employers provide their offers. On the basis of these offers a database of jobseekers and a database of employers are formed and stored on a host server. The database is formed on the basis of the International Classification of Specialities (ICS) and the International Classification of Job Positions (ICJP). The database of jobseekers consists of two main parts. The first part of the database is formed on the basis of data obtained during the registration procedure. Another part of information about jobseekers is formed on the basis of data provided by jobseekers in the application form. These data include a name of a speciality, qualification according to ICS, a scientific degree, age, sex, a work experience, a place of residence, knowledge of languages, a required job position, according to ICJP, or a required work place, a desired salary (wage), a permanent or a temporary job needed, full-time or part-time employment needed. Jobseekers also present a Curriculum Vitae (CV) in this database. The CV can contain all the additional information about him/her, which can be interesting for employers. The database of employers also consists of the two main parts. The first part of the database of employers is also formed on the basis of data obtained during the registration procedure. Another part of information about employers is additional information about themselves. This information includes a name of a Company or another legal entity, a country, a location address, an activity category, date of foundation of the Company, a number of employees, a photograph of a Company, a Company's Web site and so on. The second part of the database of employers includes offers of employers. This information is formed on the basis of data provided by employers in the application form. These data include the name of a speciality and qualification according to ICS, offered job position according to ICJP, or a work place, a scientific degree, knowledge of languages, age, sex, a work experience, a location of the offered job, an offered salary (wage), a permanent or a casual work offered, full-time or part-time employment offered and additional characteristics of the speciality suggested by the system. Jobseekers and employers can access this database and conduct needed searching. Jobseekers implement searching with the aim to find a needed job. Employers carry out searching with the aim to find needed employees. Jobseekers and employers can perform a different sorting of search results. Upon a request of a jobseeker or an employer, a selection of desired job positions or employees can be made. A result of selection becomes available to the user.

After analysis of the acquired information, the potential partners can negotiate in the frame of the system of the global electronic job market or outside it.

The jobseekers and employers can conclude a job contract either in the frame of the system or outside the system. If the job contract is concluded within the frame of the system a number of typical contracts are offered. The contract is stored in the database for a stipulated time.

Besides, the system of electronic job market offers holding a competition for job vacancies (tender).

The system of electronic job market further offers additional services including a detailed help for working in the system with a number of examples, “Hot-line” with a consultation about the work of the system of electronic job market, juridical services dealing with problems of electronic job market, an analysis and prognosis of the job market, if required by Companies, other organizations and individuals, an analysis and prognosis of the a specific branch of the job market and a publication of the magazine with an analysis of the global electronic job market.

### BRIEF DESCRIPTION OF THE DRAWINGS

The drawings accompanying the detailed description of the invention are the following:

FIG. 1 is a principal scheme of the system of global job market.

FIG. 2 shows tables of Specialities of International Classification of Speciality in relational database.

FIG. 3 shows tables of Qualifications of International Classification of Speciality in relational database.

FIG. 4 shows tables of Positions of International Classification of Job Positions in relational database.

FIG. 5 is a principal scheme of the method of operation of global job market.

FIG. 6 is a detailed description of the registration block.

FIG. 7 discloses the process of creating the database of jobseekers.

FIG. 8 shows the application form for creating of database of jobseekers.

FIG. 9 shows the structure of table of database of jobseekers.

FIG. 10 discloses the process of creating the database of employers.

FIG. 11 shows the application form for creating of database of offers of employers.

FIG. 12 shows the structure of table of database of offers of employers.

FIG. 13 discloses the process of searching for a needed job by a jobseeker.

FIG. 14 shows the application form for preparation of request of jobseekers.

FIG. 15 shows the application form for preparation of request of employers.

FIG. 16 discloses the process of searching for needed employees by an employer.

FIG. 17 discloses the process of sorting of search result.

FIG. 18 discloses the process of selecting of search result.

FIG. 19 discloses the process of searching for a needed job by a jobseeker on the basis of an expanded request.

FIG. 20 discloses the process of searching for needed employees by an employer on the basis of an expanded request.

FIG. 21 shows a detailed description of the transaction block.

FIG. 22 shows a detailed description of the process of concluding of job contracts.

FIG. 23 shows a detailed description of the process of a competition for job vacancies.

FIG. 24 shows additional services of the system of global job market.

### DETAILED DESCRIPTION

Under the term “the global electronic job market” we shall understand the international job market, which is realized with help of the Internet, because the Internet is the global device and is accessible to the majority of people of a planet.

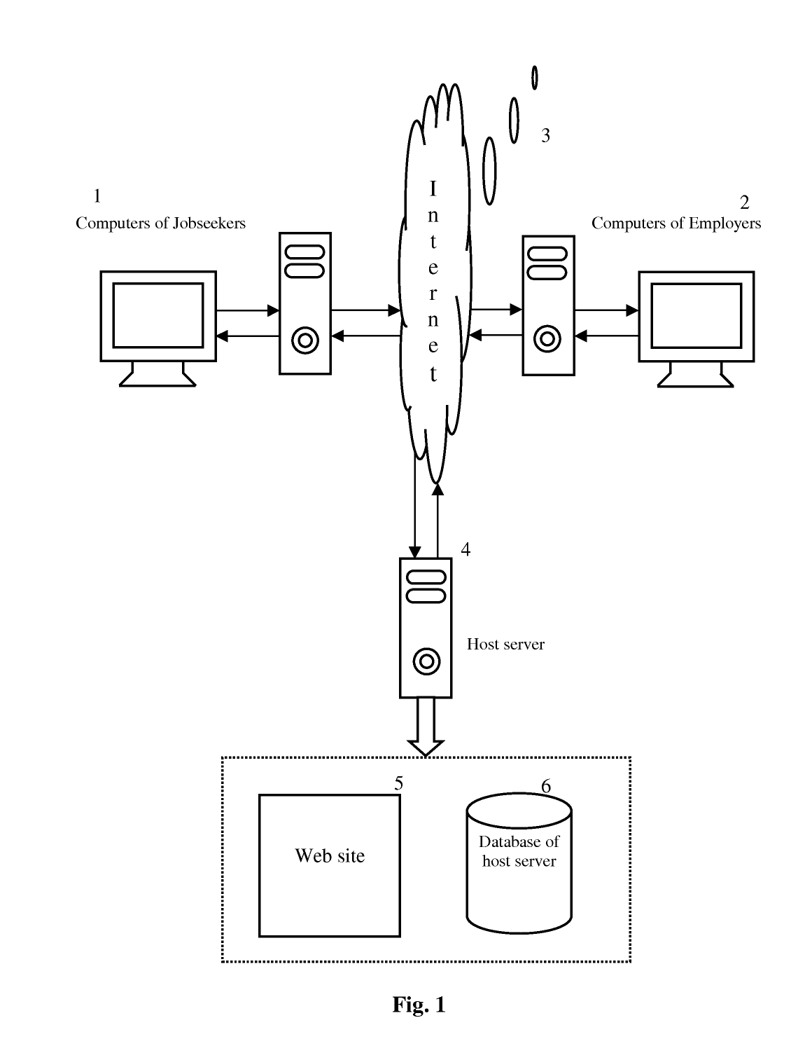

The system of the global electronic job market for the users including employers and jobseekers (FIG. 1) includes computers of jobseekers 1 and the computers of employers 2, interacting by means of the Internet 3 with Web site 5, located on the host (main) server 4; a database 6 located on the host (main) server which includes the information about jobseekers, and the information about offers of employers. Besides, the database 6 includes the International Classification of Specialities and the International Classification of Job Positions.

The system of the global electronic job market cannot function without the Internet, without computers of users and without the main server, where the Web site and the database of the system are located. The Internet provides communication between computers of users and the main server. By means of the computers users can come in the Web site of system of the global electronic job market to find work or to find the employee. The initial information for creation of databases of the information about jobseekers and information about offers of employers is formed by means of the Web site (5, FIG. 1) on computers of users (1, 2, FIG. 1). This information by means of Internet communication channels (3, FIG. 1) transfers to the main server (4, FIG. 1) and is stored in the database on disks of the main server (6, FIG. 1). On the basis of requests of users take place a search and selecting of the necessary information from the database of the main server. The received information by means of Internet communication channels transfers to computers of users.

Thus, the system of the global electronic job market represents the complex of the hardware, namely: the Internet, computers of users, the main server; and the Web site and the database. The primary goal of system of the global electronic job market is formation and storage of the information about jobseekers, and about offers of employers, transformation of this information according to requests of users, and transfer of the transformed information to users. To carry out the specified problem is possible only at presence both the Internet hardware and the Web site and the database.

The database (6, FIG. 1) of main server includes the International Classification of Specialities. Under the term “the speciality” we shall understand a complex of knowledge, which were got by a special preparation and by a work experience; and a complex of the skills necessary for a certain kind of activity. Obviously that, any jobseeker on a job market wishes to find work first of all on the speciality, received in the course of learning process, or the speciality received as a result of a work experience. Any employer on a job market wishes to find the worker who has a speciality necessary for the employer. If the jobseeker and the employer specifies the same name of a speciality in their requests, the system of the global electronic job market under the speciality name will easily and precisely throw them together. The big complexity consists in that the jobseeker and the employer have specified strictly same name of a speciality. For the decision of this problem and successful search in system of the global electronic job market the system should offer users the International Classification of Specialities. We shall understand under classifications of specialities the systematized grouping of names of the specialities, based on their relation with certain branches (sub-branches) of economy.

Now such International classification does not exist. To create such International classification is possible. There is a wide experience on creation of classifications of specialities in the separate countries. In Russia it is used Classification of Specialities by education (The all-Russian Classificator of specialities by education. It is accepted and installed by the decision of Gosstandart of Russia from 30 Sep. 2003 No 276). Specialities-professions are confirmed by the Ministry of Labour of Russia (the All-Russian Classificator of professions of workers, positions of clerks and tariff categories on 1 Jan. 2000). The Classificator of specialities of a bachelor degree and magistracy of Republic Kazakhstan SC RK 08-2004, the confirmed order of Committee on standardization, metrology and certification from 12 Mar. 2004 the order No 875 etc. There are other various classifications by work which are close to classification of specialities and can be used in its working out. In the USA the Dictionary of Occupational Titles is used. NOC (National Occupational Classification 2006) is available in Canada. There is International Standard Classification of Occupations etc.

Now the job market already became for a long time international. And last decades the international character of a job market only amplifies. If users specify names of specialities on the basis of documents on education, duty regulations and the other documents used in separate firms, in the separate countries, then a high probability exist, that different users of system call the same speciality differently. It is inadmissible for carrying out of electronic search, as it will be impossible to join the different names of specialities, specified by users. For the decision of this problem the system of the global electronic job market should unify available names of the same specialities in the different countries and to offer users the International Classification of Specialities where one accurate name will be given for each speciality. In this case unification is a reduction of available various names of any speciality to one. Certainly it not will be absolutely new names of specialities. Classification of specialities suitable for the international electronic job market can be originally created on one of languages (for example English), and then is translated on languages of participants of the international job market. For unequivocal interpretation of names of an each speciality the each speciality should have the short explanation opening its essence. In the specified classification the known names of specialities should be presented full enough, so that any user of system could find the name of his interesting speciality in classification. For search realisation in a global job market, users should take the speciality name only from the International Classification of Specialities presented by system. Classification of Specialities should be developing. With job market development certainly there will be new specialities, which will be necessary for entering in classification. The part of existing specialities in the future will simply disappear, and they will be necessary for withdrawing from classification.

It is clear, that for creation of the unified Classification of Specialities, suitable for the international electronic job market, serious efforts of certain collective of people are required. But nevertheless, the given classification is not something abstract and incomprehensible.

The International Classification of Specialities can be presented in a view of the graph (tree) where the basic branches of a tree represent main types of activity of the person, for example: the agriculture, banking, education, the industry, a science etc. Each main type of activity of the person is subdivided into branches, for example branches of industries: building industry, the gas industry, mechanical engineering, mountain-mining industry, the petroleum-refining industry, power engineering etc. The branches of industries are subdivided on sub-branches, for example the mechanical engineering is subdivided on: the motor industry, machine-tool industry, shipbuilding, electromechanical engineering etc. At last final branches of a tree represent names of specialities, for example in motor industry, in section designing of cars: the designer of engines, the designer of the chassis, the designer of bodies of cars etc.

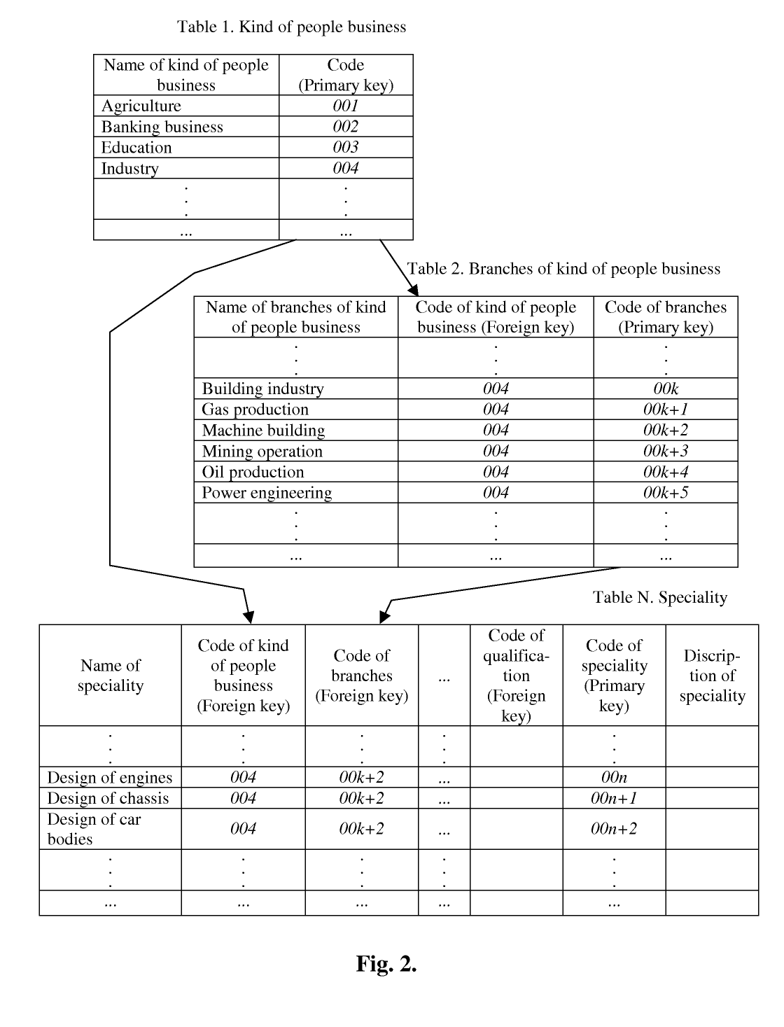

The International Classification of Specialities is placed in a database of the main server of the global electronic job market. It is necessary to realize the International Classification of Specialities in a relational database. Therefore the International Classification of Specialities will represent group of the related tables. The first table (FIG. 2) represents main kinds of people business (main types of activity of the person). In it are available two basic fields: the names of the main kind of people business and the codes of this main kind of people business, being a primary key. The names of main kind of people business are presented in a text format, and the codes of each main kind of people business are presented in a digital format.

Branches of each kind of people business also are presented in the form of table 2 (FIG. 2). The basic fields represent names of branches of main kind of people business in a text kind, codes of branches of kind of people business, a representing primary key, and a foreign key representing digital codes of main kind of people business from table 1. Last from tables (the Table N, FIG. 2) represents the table of specialities. In it, as well as in the previous tables, are available two basic fields: the name of a speciality and the code of a speciality representing a primary key. The speciality name is presented in a text format, and the code of each speciality is presented in a digital format. According to rules of relational databases, the primary key of any table of data is unique. This means that there can not be repeating codes of specialities in the table of specialities. Except the specified two fields at the table of specialities are present fields, the representing foreign keys related with all primary keys of all previous tables of the International Classification of Specialities, and a field in which the description of each speciality is presented in a text format.

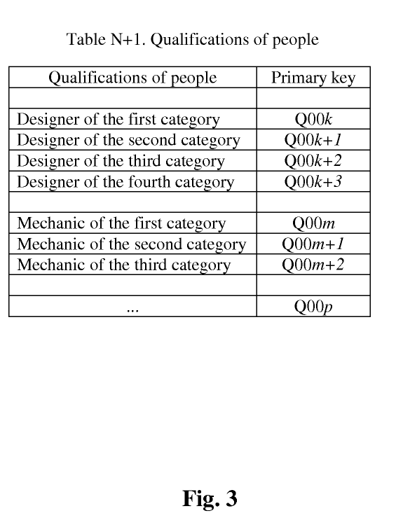

Under the term “the qualification” we shall understand a level (degree) of readiness for work performance on this or that speciality. For example, qualification of the worker can be established in the form of the category or of the rank. Therefore except above listed tables the International Classification of Specialities contains the table of qualifications (FIG. 3). In the table of qualifications are available two basic fields: the name of qualifications and the code of qualification, which is a primary key. The table of specialities (FIG. 2) will have a foreign key, which is related with a primary key of the table of qualifications.

Tables of the International Classification of Specialities will be presented in various languages of participants of the global (international) electronic job market. At language switching on the main page of the Web site the International Classification of Specialities will be presented in the language chosen by the user.

For search realisation on the job market many jobseekers wish to specify a job position demanded by him, and employers wish to specify offered job position.

Under the term “the job position” we shall understand the office place connected with execution of certain official duties, which are stipulated in duty regulations. Specific targets, which solve on each workplace, are specified in duty regulations. The knowledge (education) necessary for performance of duties; the demanded speciality and qualification are specified also in duty regulations. Now there are in some countries classifications of job position. So in Russia there is a Qualification directory of job positions of managers, experts and other employees (Approved by The decision of Ministry of Labor of the Russian Federation from Aug. 21, 1998 N 37) (with changes from January, 21st, on Aug. 4, 2000, on Apr. 20, 2001); in Republic Kazakhstan the Qualification directory of job positions of managers of experts and other employees is developed (It is confirmed by the order of the Minister of Labour and Social Protection of population RK from Nov. 22, 2002 No the 273-p), etc.

The unified International Classification of Job Positions also is necessary for the International job market. In the various countries (and it is simple in various firms) there can be various names at the same job positions. In the International Classification of Job Positions offered by the system of global electronic job market, for each job position there is only one unified name. In the specified classification the known names of job positions should be presented full enough, so that any user of system could find the name of his interesting job position in classification. For search realisation in a global job market users of system should use the names of job positions only specified in the International Classification of Job Positions of system. The International Classification of Job Positions suitable for the international electronic job market originally can be created also on one of languages (for example English), and then is translated on languages of participants of the International job market. For unequivocal interpretation of names of each job position the each job position should have the short explanation opening its essence. The International Classification of Job Positions should be developing.

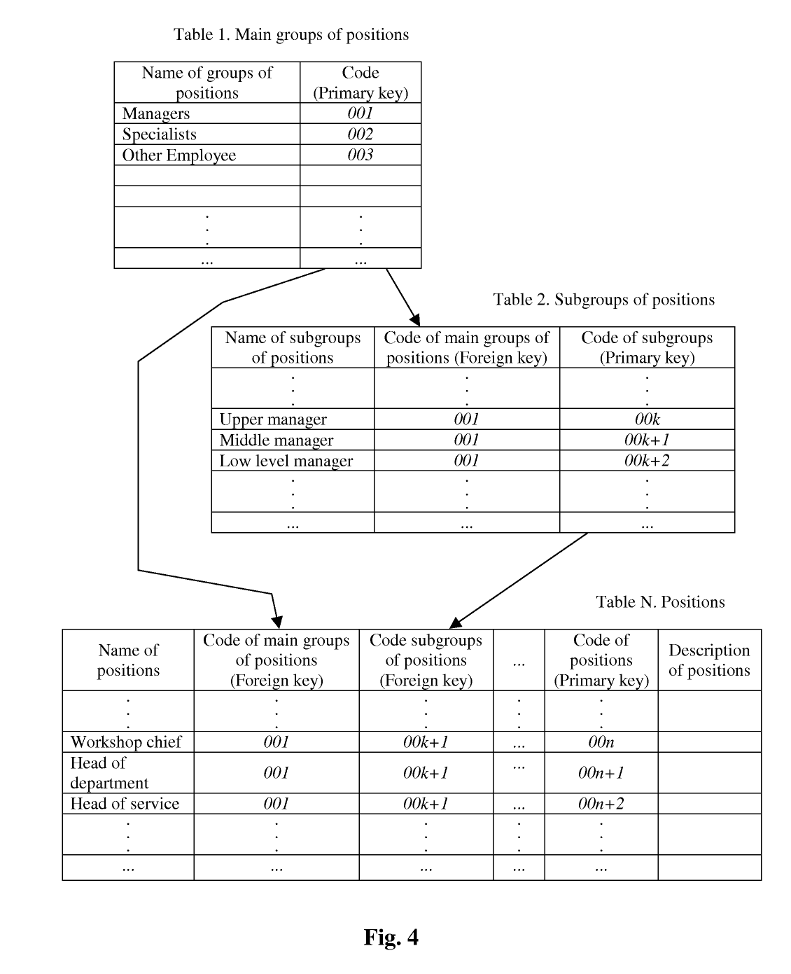

The International Classification of Job Positions can be presented in a view of the graph (tree) where the basic branches of a tree represent the basic groups of job positions, for example: managers, specialists, other employees, etc. Each basic group of job positions is subdivided into subgroups, for example upper managers, middle managers, low level managers etc. At last final branches of a tree represent job positions, for example for middle managers: the workshop chief, the head of department, the head of service etc. In system of a global electronic job market the International Classification of Job Positions is placed in a database of the main server. The International Classification of Job Positions is realized in a relational database. Therefore, as well as in the previous case, the International Classification of Job Positions will represent group of the related tables. The first table (FIG. 4) represents the basic groups of job positions. In it are available two basic fields: the name of the basic groups of job positions and the code of these groups, which is a primary key. The names of the basic groups of job positions are presented in a text format, and the codes of each group are presented in a digital format.

Subgroups of the basic job positions also are presented in the form of table 2 (a FIG. 4). The basic fields represent names of subgroups of job positions in a text format, a code of subgroups of the job positions, a representing primary key, and the foreign key representing digital code of the basic groups of job positions from table 1. Last from tables (the Table N, FIG. 4) represents the table of job positions. In it, as well as in the previous tables, are available two basic fields: the name of a job position and the code of a job position representing a primary key. The job position name is presented in a text format, and the code of each job position is presented in a digital format. As well as in the previous case in the table of job positions there can not be repeating codes of job positions. Except the specified two fields at the table of job positions are present fields, the representing foreign keys, related with all primary keys of all previous tables of the International Classification of Job Positions, and a field in which the description of each job position is presented in a text format.

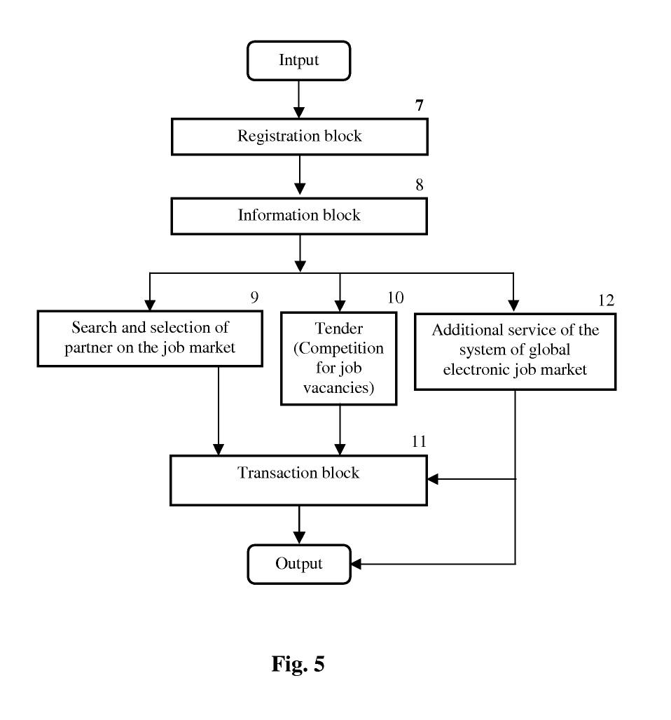

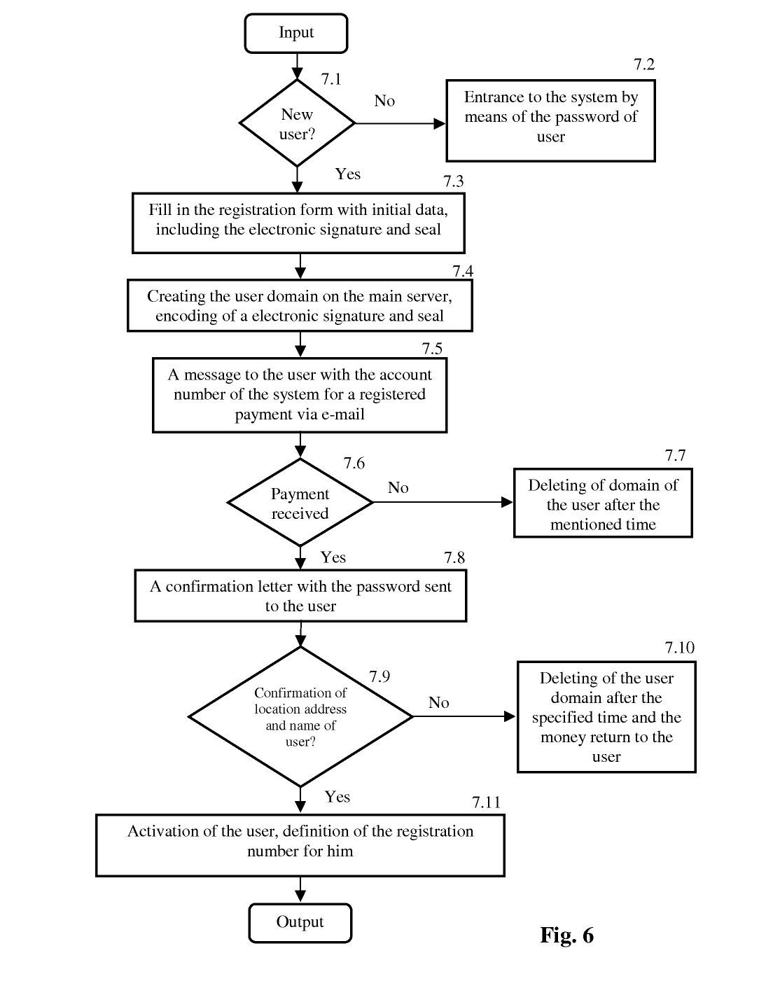

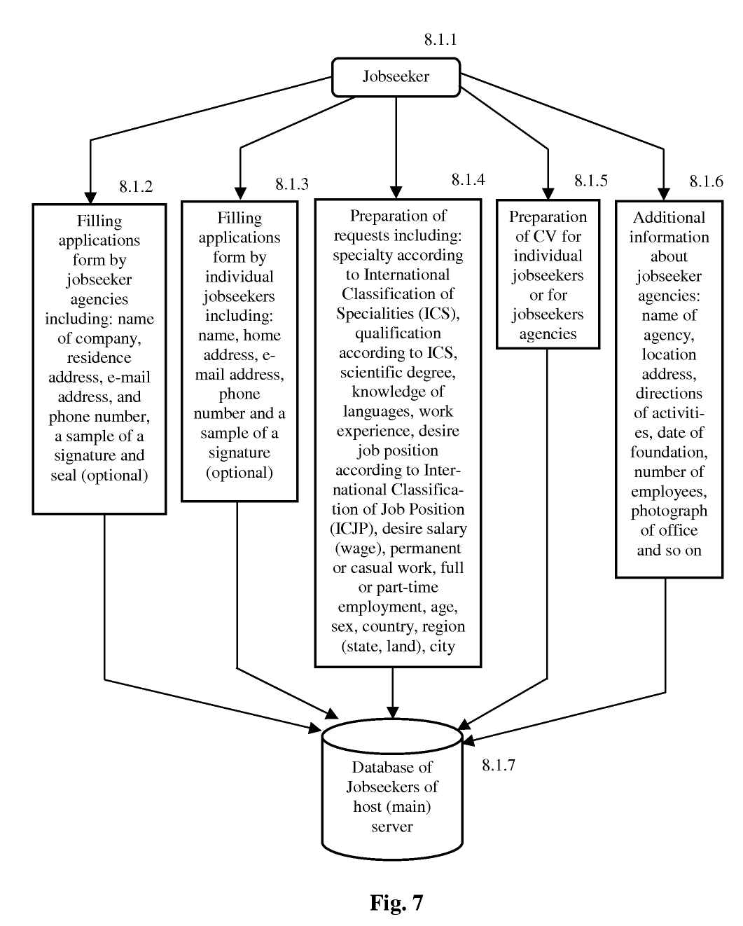

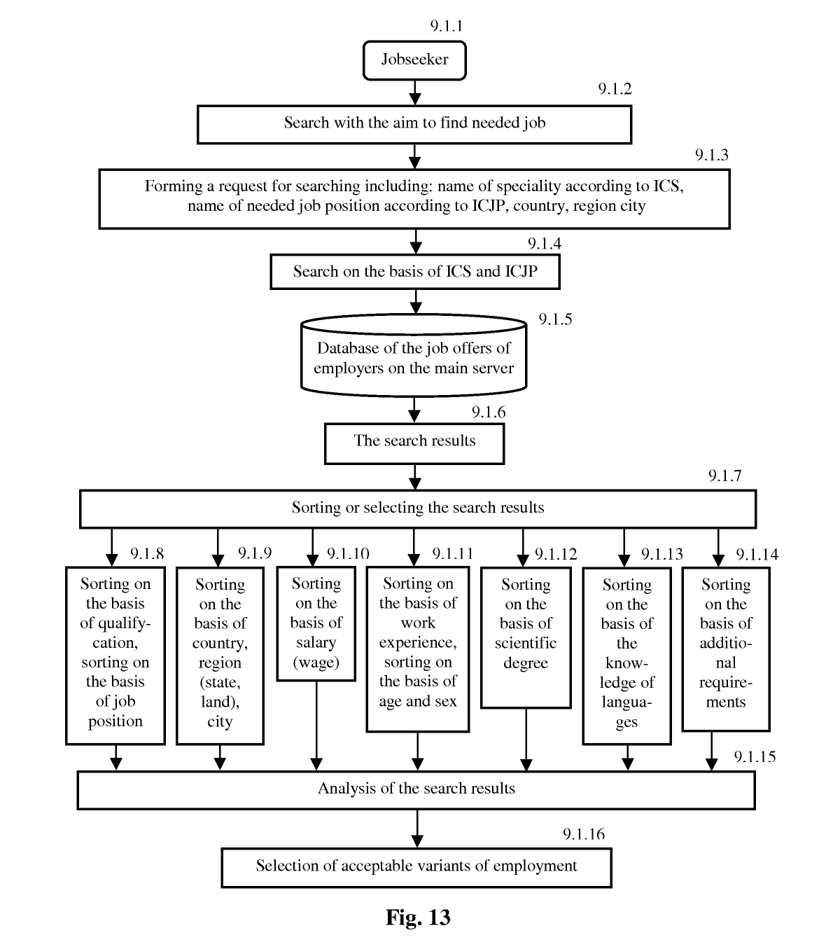

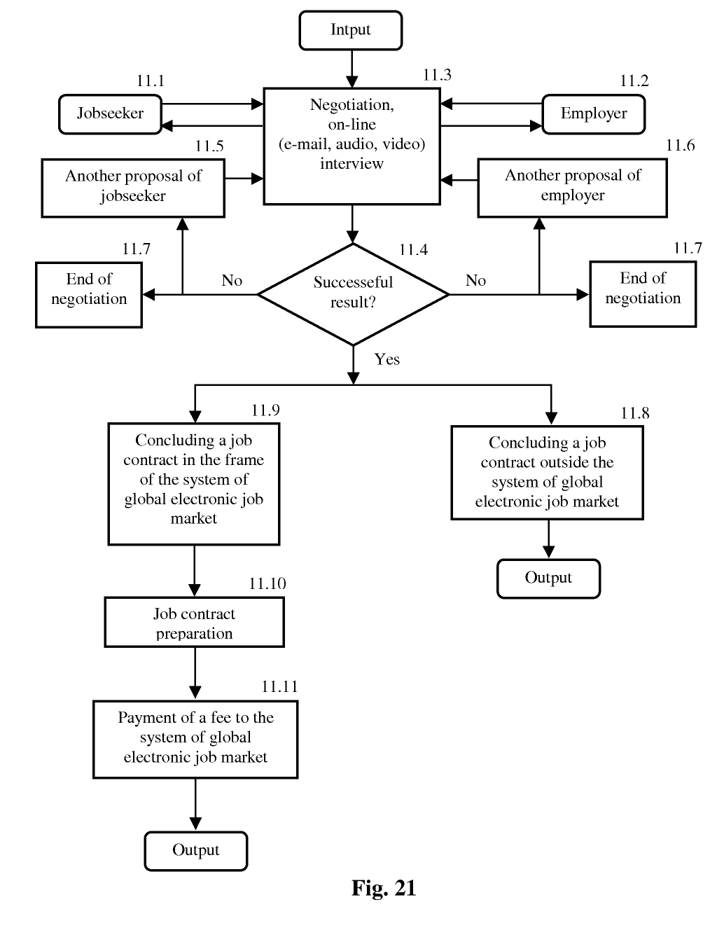

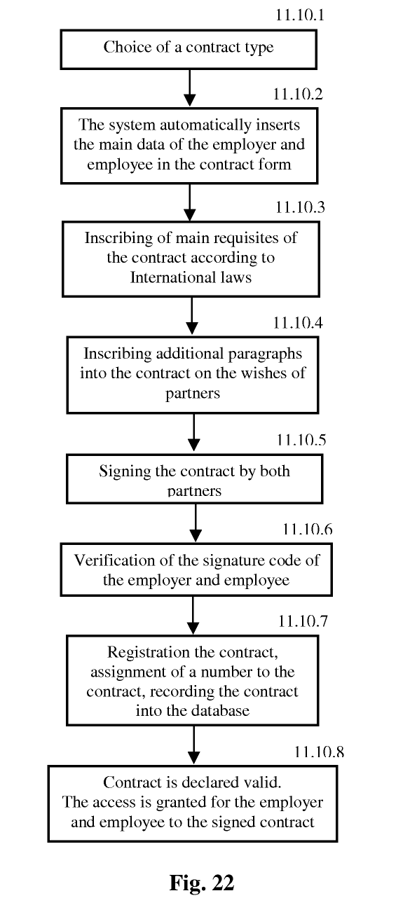

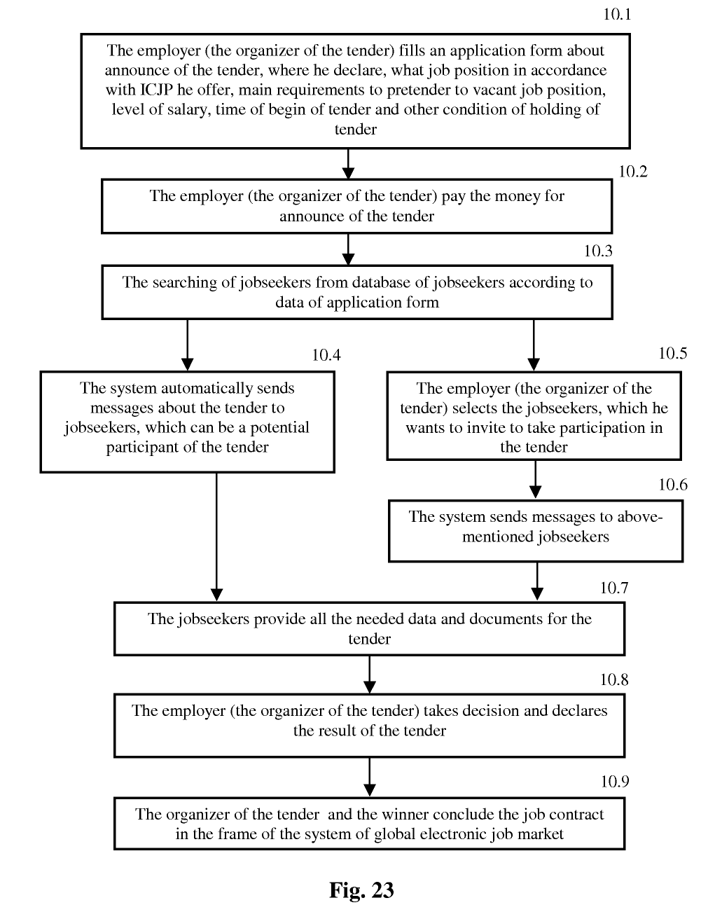

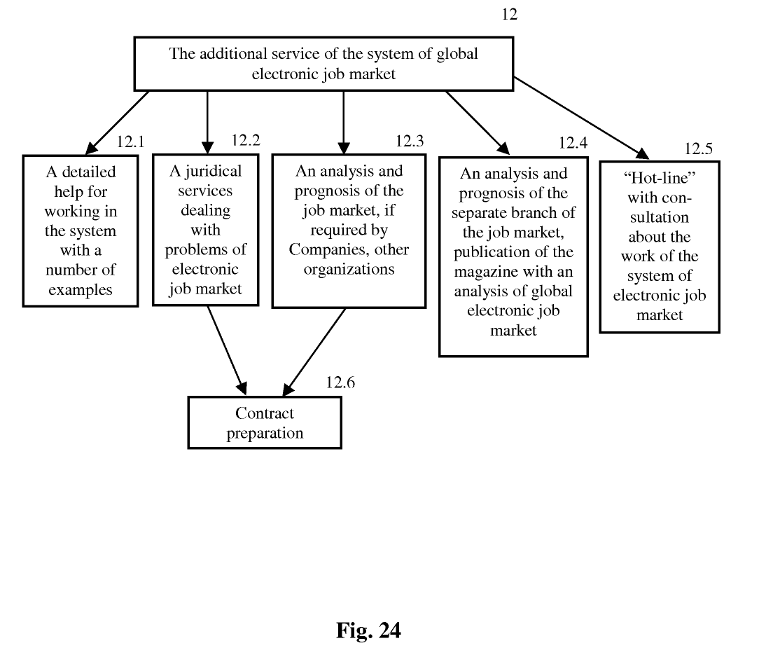

According to the invention, a method of operation of the global electronic job market (FIG. 5) includes a registration block (7—see FIG. 6), an information block (8—see FIGS. 7-12), a block of search and selection of a partner on the job market (9—see FIGS. 13-20), a block of competitions for job vacancies (10—see FIG. 23), a transaction block (11—see FIGS. 21-22) and a block of additional services of the system of global job market (12—see FIG. 24).

In order to register, the user must complete a registration form (7.3) (FIG. 6). This form includes data about a company (or another legal entity): a name of the company or another juridical person, a location address, an e-mail address and a telephone number. If the user is a company or another legal entity and the user wants to sign a job contract in the frame of the system of global job market or other documents of the system, he has to fill in the name and the position of his official representative, who will sign job contracts and other official documents on behalf of the company or another juridical person. The company or another legal entity has to provide an example of the official scanned signature. Companies having seals according to articles of association provide a sample of a scanned print of the seal.

If the user is an individual businessman, he/she includes his/her name in the registration form, the location address, an e-mail address and a telephone number. If the user is a private individual, he/she has to include his/her name in the registration form, the home address, an e-mail address and a telephone number. If individual users want to sign job contracts and/or other official documents in the frame of system of global job market, they have to give a scanned image of their signature.

The name of a company or another entity and the name of individual users or their registration numbers in the system will be accessible only for the registered users of the system of global job market. Other information, presented in registration forms, is considered confidential and will be unavailable. This information can be used for a job contract preparation and other official documents of the system of global job market. Upon a request of individual users, their name in the system of global job market can be replaced by their registration number in the system, for example: “Individual businessman, registration number N” or “Private individual, registration number N”.

The system allocates a user domain for a new user (7.4). In this domain all the user data will be stored. The system encodes the electronic signature and the seal of users.

Upon completion of the registration form by users, the system will send a message (7.5) to the provided e-mail address of the user with an account number, where the user must pay a registration fee. This fee is intended to discourage casual users who can potentially impede the normal operation of the system.

If no payment is received during a certain period after the registration then the system deletes the allocated user domain with all the data (7.7).

After receiving the registration fee, a letter is sent to the user with the password by an express position (7.8) with a notification of the receipt. If users require so, the system will enclose with that letter a code of signature and a code of seal.

A confirmation (7.9) will be conducted. If no confirmation is acquired either of the user's location address as specified in the application form, or the company name or the name of private person, the system locks the reserved user domain. If the user does not send a message to the system during a certain period, the system deletes a reserved user domain and returns the registration fee (7.10).

In case of confirmation of the user data, the system activates the user (7.11), his/her password and provides a registration number, which gives the user an access to the system of electronic job market.

After filling the registration form the user concludes an agreement with the system. This way the user confirms his responsibility for any breach of the national and International laws.

A user as a juridical person will be able to modify the name of the company. A user as a private person can change his/her name. But in order to activate changes the user must repeat the registration procedure.

The information block includes the following databases. There are two main databases, namely the database of jobseekers and the database of employers.

The database of jobseekers (8.1.7) (FIG. 7) consists of two parts. The first part of the database of private persons and companies, who are jobseeker agencies, is formed on the basis of data obtained during the registration procedure (8.1.2-8.1.3). This information is considered confidential.

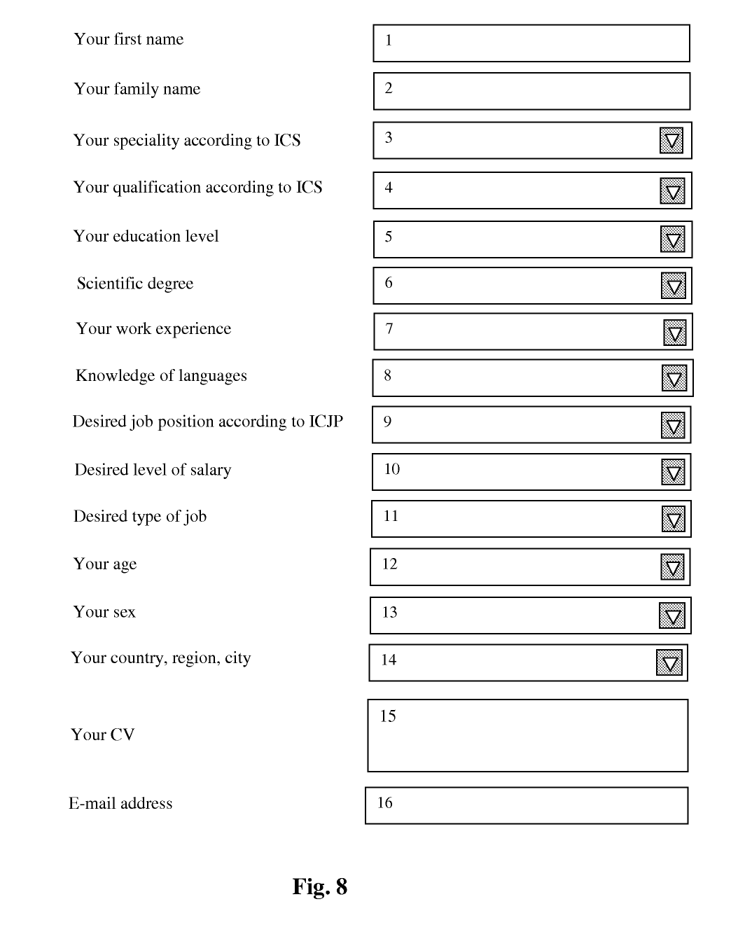

Another part of information about jobseekers is formed by jobseekers after the registration procedure (8.1.4-8.1.6). This part of a database contains the information about jobseekers. It is formed on the basis of data, which the jobseeker enters in the special application form (FIG. 8). In first two fields of the application form the jobseeker enters the name and a surname. In the third field the jobseeker enters the name of its speciality. He does it by means of the International Classification of Specialities. After pressing a triangle in a field the user will receive the popup menu with the classification presented in the form of a tree, for example as in the Internet an explorer. After that the user reaches on a tree the name of the necessary speciality and presses on this name. After that the speciality name will appear in the field. In the field 4 the jobseeker precisely also enters the name of the qualification from the table of qualifications of the International Classification of Specialities. In the field 5 the user enters a level of the education, which he will choose from the popup list, for example: the higher (university), the higher (technical university), the higher (college), an average (grammar school), an average special etc. Data, which appear in popup menus or in popup lists, are stored in corresponding tables of a database of the main server. In the field 6 the user enters a scientific degree if he has it. Data he will choose from the popup list, for example: Dr. of Science, PhD. In the field 7 the jobseeker enters the experience of work which he as well as in the previous case chooses from the popup list, for example: till 3 years, from 3 till 5 years, from 5 till 7 years, from 7 till 10 years, from 10 till 15 years, from 15 years till 20 years, over 20 years etc. In the field 8 the jobseeker enters data about knowledge of languages. In the beginning the user will enter data about the native language, then data about knowledge of foreign languages. The user will select this data from a popup menu. In the field 9 the jobseeker enters the name of a job position, which he would wish to receive. He does it by means of the International Classification of Job Positions as well as in case of a choice of the speciality. In the field 10 the user enters a level of salary, which he would wish to receive which level he will choose from the popup list. In the field 11 the jobseeker enters data about type of work, which he would wish to receive. He will choose type of work from the popup list, for example: the constant or the temporary job, the full or incomplete working day etc. In the field 12 the jobseeker enters the age from popup list. In the field 13 the jobseeker enters a sex from popup list. In the field 14 the jobseeker specifies the country, the region and the city from the popup list. In the field 15 the jobseeker enters a Curriculum Vitae (CV). The CV can contain all the additional information, which can be interesting for employers. For example, this information can include a description of acquired education, a detailed description of the work experience, professional skills and so on. The system will provide recommendations for the preparation of CV in main languages. Information about education has a high priority. This information can include the name of speciality and qualification according to a diploma or a certificate, a name and location of an educational institution, where the jobseeker graduated from, the year of graduation, the number of the diploma or the certificate. The CV can be presented in English and in a native language. Jobseekers representing jobseeker agencies provide CVs of their clients. In the field 16 the jobseeker enters the address of e-mail.

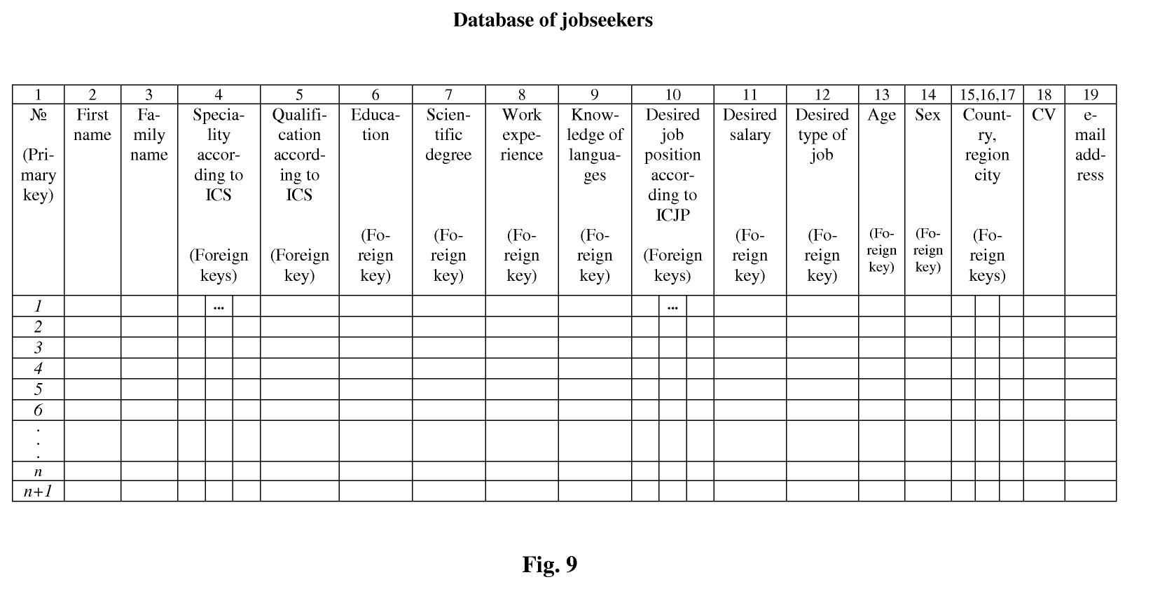

After filling of the specified form, data about the jobseeker get to the row of the database containing the information about this person (a FIG. 9). The field 1 of the basic table of the database represents identification number (a primary key), which can coincide with number of a row for example. In the fields 2 both 3 the name and the surname of the jobseeker registers. The group of fields 4 further follows. These fields contain the information about a speciality, which was chosen by the user. The codes of all branches, the codes of sub-branches and at last the code of the chosen speciality from the last Table N of the International Classification of Specialities will be entered in this field (FIG. 2). All these fields will be the foreign keys related with primary keys of all tables of the International Classification of Specialities. In the group of fields containing the information about a speciality, the information related with the International Classification of Specialities will get only. No other information will get to this group of fields because the user has chosen the name of a speciality from the International Classification of Specialities. In the field 5 the code of qualification according to the name of qualification of a corresponding speciality which was chosen by the user from the International Classification of Specialities will be written down. This field will be the foreign key related with the primary key of the table of qualifications of the International Classification of Specialities. Only the information, related with the International Classification of Specialities, can be written in this field. No other information will get to this field. In fields 6, 7, 8 and 9 the codes of the information of an educational level, of a scientific degree, of the work experience, of knowledge of languages will be written. These codes are primary keys of corresponding tables of a database. Fields 6, 7, 8, and 9 will be foreign keys of corresponding tables of the database. The group of fields 10 containing the information about job position, which the jobseeker would like to receive, follows further. Codes of all groups of positions, subgroups of positions and at last a code of position, which the jobseeker would like to receive from the last Table N of the International Classification of Job Positions (a FIG. 4), will be entered in this field. All of these fields will be the foreign keys related with primary keys of all tables of the International Classification of Job Positions. Only information related with of the International Classification of Job Positions will get in the group of fields containing the information about a job positions, because the user has chosen the name of a job position from the International Classification of Job Positions. No other information will get to this field. In fields 11, 12 codes of the information about the desirable salary and about desirable type of work will get. These codes are primary keys of corresponding tables of a database. Fields 11 and 12 will be foreign keys of corresponding tables a database. In fields 13, 14 codes of the information about an age and about a sex of jobseeker will get. These codes are primary keys of corresponding tables of a database. Fields 13 and 14 will be foreign keys of corresponding tables a database. In fields 15, 16, 17 codes of the information about the country, the region, and the city, where the jobseeker lives, will get. These codes are primary keys of corresponding tables of a database. Fields 15, 16 and 17 will be foreign keys of corresponding tables a database. In the field 18 takes places CV the jobseeker. In the field 19 the e-mail address of the jobseeker is located. Data being in fields 4-17 are related with data of corresponding tables of a database of the main server.

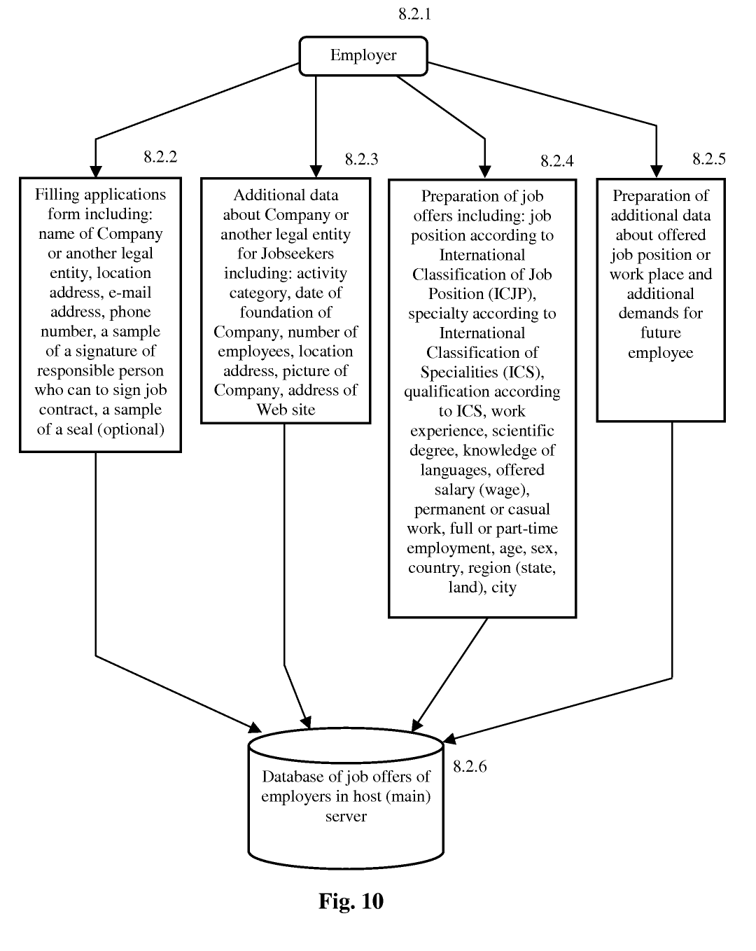

Jobseekers representing jobseeker agencies can provide additional information about their agencies (8.1.6) (FIG. 7), such as the name of the agency, a location address, directions of activities, the date of foundation, the number of employees, a photograph of an office and so on. The database of employers (8.2.6) (FIG. 10) also consists of the two parts. The first part of the database of employers is formed on the basis of data obtained during the registration procedure (8.2.2). This information is considered confidential.

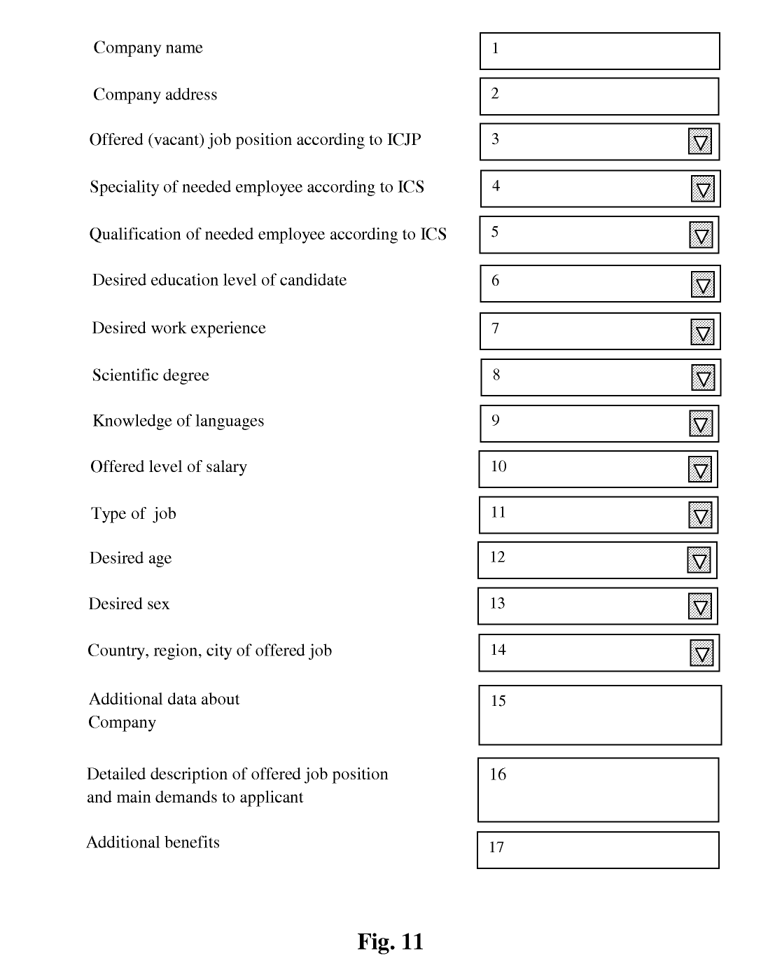

Another part of information about employers is provided by employers after the registration procedure (8.2.3-8.2.5). This part of a database contains the information about offers of employers. It is formed on the basis of data, which the employer enters in the special application form (FIG. 11). In the field 1 the employer enters the company name. In the field 2 the employer enters the address of the company, which contains the post address and a name of the person for contact, an e-mail address and a name of the person for contact, name of a Web site. In the field 3 the employer enters the name of the vacant job position. He does it by means of the International Classification of Job Positions. After pressing a triangle inside the field the user will receive the popup menu with the classification presented in the form of a tree, for example, as in the previous cases. After that the user reaches on a tree the name of the necessary job position and presses it. After that the name of the job position will appear in the field. In the field 4 the employer enters the name of the speciality, which the candidate on a vacant job position should have. He enters the name of the demanded speciality from the International Classification of Specialities, as well as in the previous cases. In the field 5 the employer enters the name of qualification from the International Classification of Specialities, which is necessary for the candidate on the vacant job position. In the field 6 the employer enters a necessary educational level of the candidate on the vacant job position, which employer chooses from the popup list. Data, which appear in popup menus or in popup lists, are stored in the same tables of a database of the main server, as in the previous case. In the field 7 the employer enters the experience of work, which the candidate on the vacant job position should have. The employer chooses the demanded experience of work from the popup list. In the field 8 the employer enters the name of a scientific degree, which the candidate on the vacant job position should possess. The employer chooses a scientific degree from the popup list. In the field 9 the employer inserts data about languages, which the candidate should know. In the field 10 the employer inserts level of the offered salary. In the field 11 the employer inserts work type: the constant or the temporary job, the full or incomplete working day etc. In the field 12 the employer will insert desirable age of the candidate for the vacant job position, if he have interest to this information. In the field 13 the employer will insert a desirable sex of the candidate for the vacant job position, if this information will have for him any value. In the field 14 the employer specifies the country, region and a city where there is a specified vacant job position. The data in fields with 9 on 14 are brought from popup lists or the menu. In the field 15 the employer can insert additional data about the companies, for example year of foundation of the company, a type of company activity, a number of the personnel etc. In the field 16 the employer can insert the detailed description of an offered vacant job position and the additional requirements to the candidate. In the field 17 the employer can insert the description of side benefits, for example: the paid medical insurance, the paid pension insurance, the duration of holiday, the car, given by the company, paid bonuses, payment for a fitness club and others.

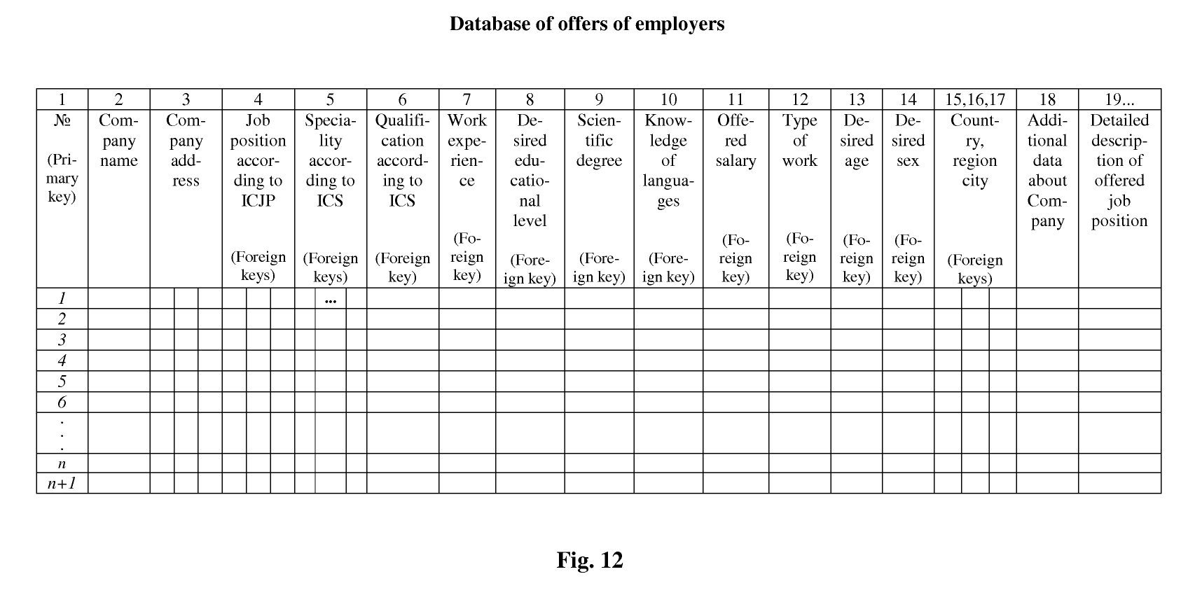

After filling of the specified application form, data about the offer of the employer get to the row of a database containing the information about this offer (FIG. 12). The field of 1 basic table of the database represents identification number (a primary key), which can coincide with number of a row for example. The name of the company and its address gets to fields 2 and 3. In group of fields 4 the information about the vacant job position which is offered by the employer is contained. The codes of all groups of job positions, the codes of subgroups of job positions and at last a code of the chosen job position from the last Table N of the International Classification of Job Positions (a FIG. 4) will be entered in these fields. All of these fields will be the foreign keys related with primary keys of all tables of the International Classification of Job Positions. Only the information related with the International Classification of Job Positions will get in the group of fields containing the information about the vacant job position, because user has chosen the name of a job position from the International Classification of Job Positions. No other information will get to these fields. The group of fields 5 contains the information about the speciality, which is required for the candidate on a vacant job position. The codes of all branches, the codes of sub-branches and at last a code of the chosen speciality from the last Table N of the International Classification of Specialities (FIG. 2) will be entered in these fields. All of these fields will be the foreign keys related with primary keys of all tables of the International Classification of Specialities. Only the information related with the International Classification of Specialities will get in the group of fields containing the information about the speciality, because the employer has chosen the name of a speciality from the International Classification of Specialities. No other information will get to these fields. In the field 6 the qualification code will be written down, according to the name of qualification of the speciality, which the employer has chosen from the International Classification of Specialities. This field will be the foreign key related with the primary key of the table of qualifications of the International Classification of Specialities. Only the information related with the International Classification of Specialities will get to this field. No other information will get to this field. In fields 7, 8, 9 and 10 codes of the information about demanded the work experience, about an educational level, about a scientific degree and about knowledge of languages will get. These codes are primary keys of corresponding tables of a database. Fields 7, 8, 9, and 10 will be foreign keys of corresponding tables a database. In fields 11, 12 codes of the information about the offered salary and about work type will get. These codes are primary keys of corresponding tables of a database. Fields 11 and 12 will be foreign keys of corresponding tables a database. In fields 13, 14 codes of the information about wished age and sex of the candidate on a vacant job position will get. These codes are primary keys of corresponding tables of a database. Fields 13 and 14 will be foreign keys of corresponding tables a database. In fields 15, 16, 17 the information about the country, the region, and the city where there is an offered vacant job position gets. These codes are primary keys of corresponding tables of a database. Fields 15, 16 and 17 will be foreign keys of corresponding tables a database. In the field 18 the information with additional data about the company gets. In the field 19 the information with the detailed description of an offered job position and with the additional requirements to the candidate gets. In the field 20 the information with the description of side benefits gets. Data being in fields 4-17 are related with data of corresponding tables of a database of the main server.

Jobseekers and employers can introduce a modification into the abovementioned information. Users can change or delete information about their offers from the system at any time. They can also insert new offers at any time. Every user has a possibility to change only his/her own information.

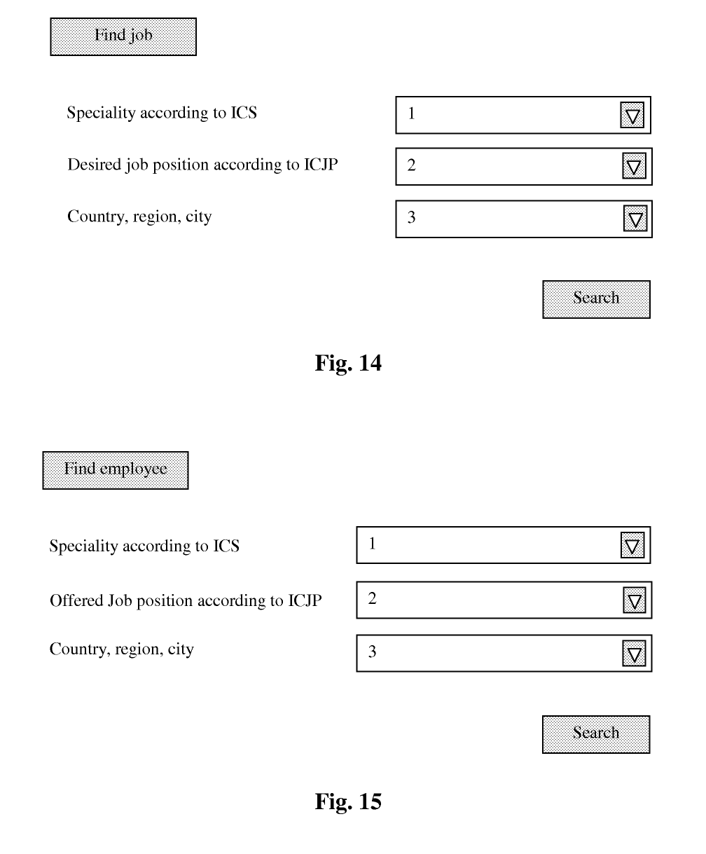

Jobseekers can perform searching with the aim to find a needed job (9.1.2) (FIG. 13). For search of vacant positions in system of the global electronic job market the jobseeker should prepare request for search (9.1.3) (FIG. 13). For this purpose he fills the special application form (FIG. 14). In the field 1 of this form the jobseeker inserts the name of the speciality according to the International Classification of Specialities. After pressing a triangle in a field of the application the user will receive the popup menu with the classification presented in the form of a tree, as well as in the previous cases. After that the user reaches on a tree the name of the necessary speciality and presses it. After that the speciality name will appear in the field 1 of the application form. If the user wishes to receive the full list of all offers on work for the jobseekers having the specified speciality from a database of the offers of employers, he can not fill the field 2 and 3. If the user wishes to receive the list of offers only with interesting for him positions on the chosen speciality, he should enter in the field 2 of forms the name of interesting positions for him according to the International Classification of Job Positions, as well as in the previous cases. If user has interest only on any country, he can choose the country, region, a city in which he wishes to find work. He can specify in the application form the place of his residence, if he wishes to work in a residing place (a field of 3 forms).

Searching and selecting of results will be carried out from the database of offers of employers (9.1.5) (FIG. 13). Search will represent the enclosed algorithm. At the first stage of search the system will consider all data in the field of specialities of the database of offers of employers (FIG. 12). The system will compare the code of the speciality from request of the jobseeker with the codes of specialities being in the field (column) of specialities of the database of offers of employers. In case of coincidence of codes, the row from the database of employers, where there was this code, will be written down in the file of results of search. The result of search will be absolutely unequivocal and complete, because the speciality code in the request of the jobseeker and the codes of specialities in the field of specialities of a database of offers of employers are written down from the International Classification of Specialities. That is, only the offers of employers having the codes coincidences with request of jobseeker will get to result of search. No other offers of employers will get to result of search. Selecting of data will be complete, that is, all data corresponding to the request which are available at the moment in the database of offers of employers will get to result of search. Any row will not be passed. At the given algorithm of search it simply is not possible.

At the second stage of searching, the select from the field of positions of the database of offers of employers will be made. The rows corresponding to a code of the position from the request of the jobseeker will be chosen from the result of searching received at the first stage of searching. At the third stage of searching, the select will be made from the field of the country, region, the city, of the database of offers of employers. That is, the rows corresponding to codes of the country, region and a city will be chosen from request of the jobseeker from the search of result received at the second stage. Search at all subsequent stages also as well as at the first stage will be also absolutely unequivocal and complete. The result of search will correspond completely to request of the jobseeker.

As a result of searching and selecting, the information, stored in the database of offers of employers and located on disks of the main server, will be transformed according to request of the jobseeker. The file with results of search will represent the table not simply with the list of offers of employers as it takes place in the database. The file with results of search will represent the table with the list of offers only those employers, the offers of which (the name of a speciality, positions, a work place) coincide with request of the searcher of work. Thus the information received by the jobseeker qualitatively differs from the information stored on disks of the main server. The information received by the user, corresponds to his request and is useful to him. The information, stored on disks of the main server, without its transformation, that is, without searching and selecting, does not represent for the user of any interest.

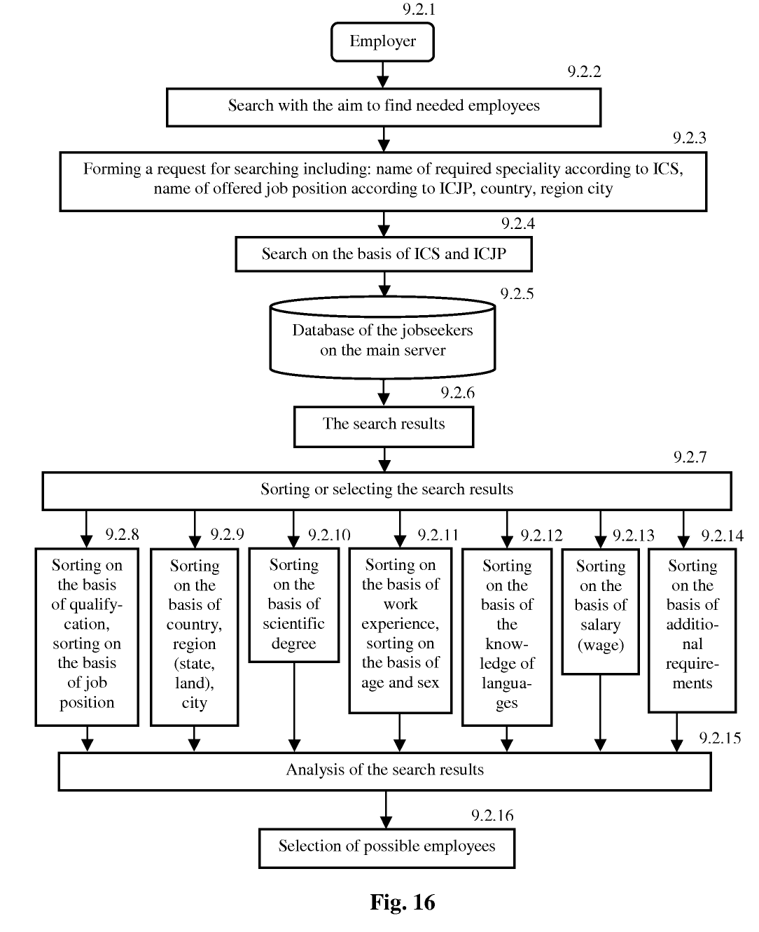

Employers can conduct searching with the aim to find needed employees (9.2.2) (FIG. 16). For search of the worker for a vacant position in the system of the global electronic job market the employer should prepare also request about search (9.2.3) (FIG. 16). For this purpose he fills the special application form (FIG. 15). In the field 1 of this form, the employer inserts the name of a demanded speciality at the required worker according to the International Classification of Specialities. If the employer wishes to receive the full list of all offers from the jobseekers having the specified speciality from the database of jobseekers, he can not fill a field 2 and 3. If the employer wishes to receive the list of offers from the jobseekers for whom the position, which is offered by the employer, is necessary, he should insert the name of the position which is offered by the employer to jobseekers in the field of 2 forms, according to the International Classification of Job Positions, as well as in the previous cases. If employer takes interest to jobseekers, which wish to find a job in the country, region, a city where the vacant place is offered, the employer should fill a field of 3 forms. Algorithm of filling of the form is precisely the same as in the previous case.

Searching and selecting of results will be carried out from the database of the information about the jobseeker (9.2.5) (FIG. 16). The search will represent the enclosed algorithm. The system of the global electronic job market will consider all data in the field of specialities of the database of the information about the jobseeker at the first stage of search (a FIG. 9). The system will compare a code of the speciality from request of the employer with codes of the specialities, which are in the field (column) of specialities of the database of the information about jobseekers. The row, where there was this code, will be written down in the file of results of search in case of coincidence of codes. The result of search will be absolutely unequivocal and complete, because the code of speciality in the request of the employer and codes of specialities in the field of specialities of a database of the information about the jobseeker are written down from the International Classification of Specialities. That is, the information about the jobseeker, which has the speciality specified in the request of the employer, will get to the result of the search only. No other data will get to the result of the search. Selecting of data will be complete. That is, all data corresponding to the request about the jobseeker having a speciality specified in the request, which are available at the moment in the database of the information about the jobseeker, will get to result of search.

Selection from the field of the positions of the database of the information about the jobseeker will be made at the second stage of search. Rows with the code of the positions, corresponding to the code of the position from the request of the employer, will be chosen from the result received at the first stage of search. Selection from the fields of the country, region, a city of the database of the information about the jobseeker will be made at the third stage of search. The rows, corresponding to codes of the country, region, a city from the request of the employer, will be chosen from the result received at the second stage of search.

Searching at all subsequent stages, also as well as at the first stage, will be also absolutely unequivocal and complete. The result of search will correspond completely to the request of the employer.

As a result of searching and selecting, the information, stored in a database of the information about the jobseeker and located on disks of the main server, will be transformed according to the request of the employer. Thus, the result of the search will correspond completely to the request of the employer. The file with results of search will represent the table not simply with the list of offers of searchers of work as it takes place in the database. The file with results of search will represent the table with the list of offers only those searchers of the work, offers of which (the speciality name, the job position name, a work place) coincide with request of the employer. Thus, the information received by the employer qualitatively differs from the information stored on disks of the main server. The information received by the employer, corresponds to his request and is useful to him. The information, stored on disks of the main server without its transformation, that is, without searching and selecting, does not represent for the employer of any interest.

Files of information, received by users as a result of searching and selecting, represent two-dimensional data files. The structure of these files completely corresponds to database structure from which they have been received. The most part of columns of such file represents the codes, which have been written down in conformity from the International Classification of Specialities or in conformity from the International Classification of Job Positions, or the codes, which have been written down from other tables of the database. That is, the information stored in these files is structured. Hence, various sorting and selecting can be made with such information.

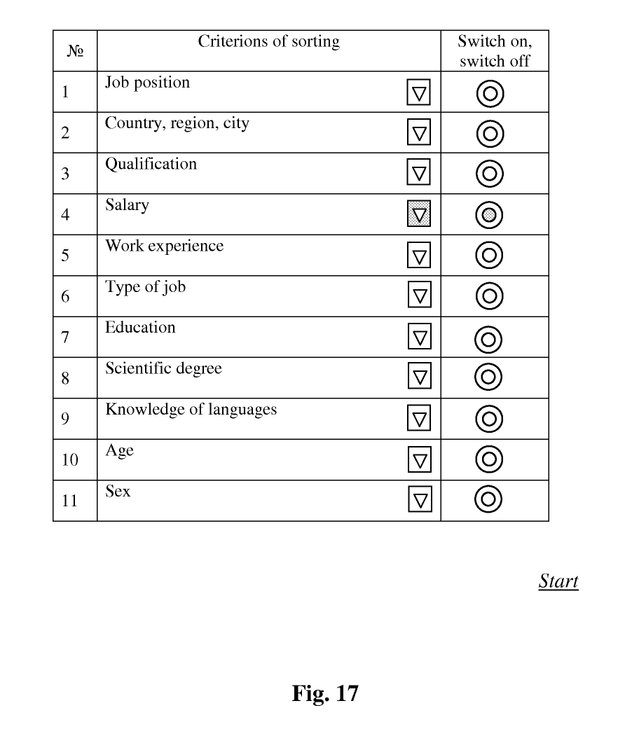

The user can make sorting of the received data (9.1.7, 9.2.7) (FIG. 13, FIG. 16) on the basis of one of the chosen criteria by means of the special form (FIG. 17). After pressing of the button in a line of the chosen criterion, the line becomes active. Sorting of results of search according to a position will be made in alphabetic order the first letter of the name of a position. The algorithm of sorting according to the name of the country, region and a city will be enclosed. In an external cycle of sorting according to the country name will be made. In a following cycle sorting under the name of region will be made and in last cycle sorting under the city name finally will be made. Sorting of results of search according to qualification will be made under qualification names. At sorting of results of search according to the salary, there will be a popup menu in which it will be offered to user to choose algorithm of sorting: on increase or on salary decrease. Sorting of results of search according to the work experience will be made according to the value of the work experience. Sorting of results of search according to work type will be made under names of type of work. Sorting of results of search according to an educational level will be made under educational level names. Sorting of results of search according to a scientific degree will be made under scientific degree names. Sorting of results of search according to knowledge of languages will be made under names of languages in alphabetic order. Sorting of results of search according to age will appear the popup menu in which it will be offered to user to choose algorithm of sorting: on increase or on age decrease. Sorting of results of search according to a sex will be made under sex names. It is necessary to notice, that the size of a file of results of search will not change as a result of sorting. The sequence of lines depending on sorting will change only.

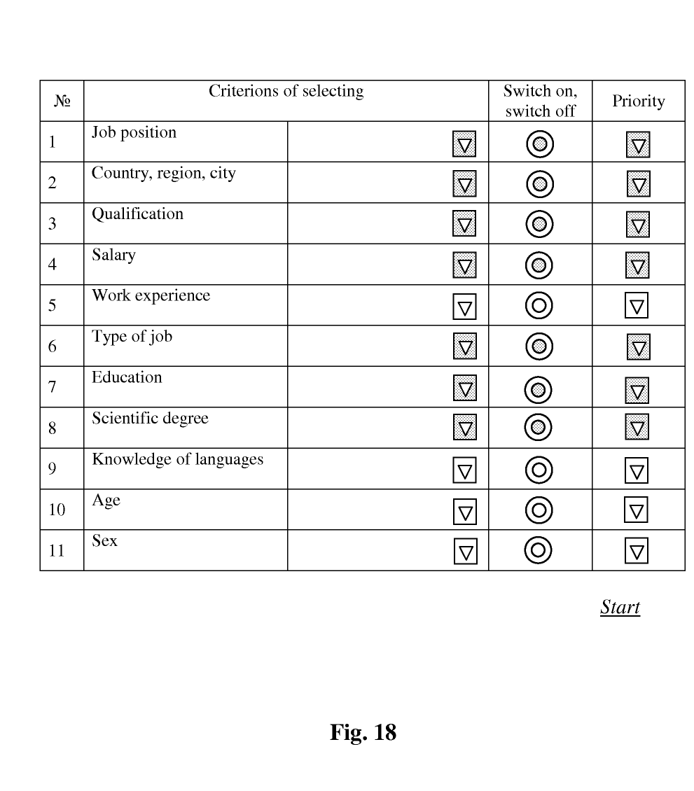

The file of results of search can be very big. For selecting of data from the file of results of search (9.1.7, 9.2.7) (FIG. 13, FIG. 16), the user of system of a global electronic job market (the jobseeker or the employer) can use the special form (FIG. 18). Names of criteria of selecting in this form coincide with the name of columns of the file of results of search. In the beginning the user chooses and includes the criteria of selecting by means of the buttons, which are in a column “Switch on, switch off”. Then the lines with the chosen criteria become active. Further the user chooses the name or size of the included criteria of selecting. The user chooses the name of a position from the International Classification of Job Positions. The user chooses the name of the country, region and a city from the popup list. The user chooses the name of qualification from the International Classification of Specialities. Salary size, size of the experience of work, the name of type of work, educational level, the scientific degree name, the language name, the level of competence in language in criterion of “knowledge of languages”, an age, sex the user chooses from the popup list or the popup menu, if the given criterion is active.

After inclusion of criteria of selecting and installation of their names and sizes, the user can establish a priority of criteria. Selecting of results of search will be carried out on the algorithm consisting of enclosed cycles. The criterion of selecting on an external cycle will possess the highest priority. The criterion of selecting on an internal cycle will possess the lowest priority. It is necessary to notice; the size of the file of results of search will decrease as a result of selecting.

Feature of algorithm of selecting is, that criteria of selecting are inserted by the user in the form (FIG. 18) from the same tables of the database, from which the data have been inserted by users in forms (FIG. 8, FIG. 11). The structure of the file of results of search represents a full copy of structure of the corresponding table of the database. Hence, codes of criteria of selecting and the data located in corresponding columns of the file of result of search are data having identical structure. The result of selecting by this or that criterion will be complete and unequivocal. That is, the information which completely coincides with criterion of selecting will get to result of selecting only. No other data will get to result of selecting. Selecting of data will be full, that is, all data corresponding to criterion of selecting which are available at the moment in the file of results of search will get to result of selecting.

After the analysis of search results (9.1.15) (FIG. 13) the jobseeker can get a list of more acceptable variants of employment (9.1.16). And after the analysis of search results (9.2.15) (FIG. 16) the employer can get a list of more acceptable candidates for employment (9.2.16).

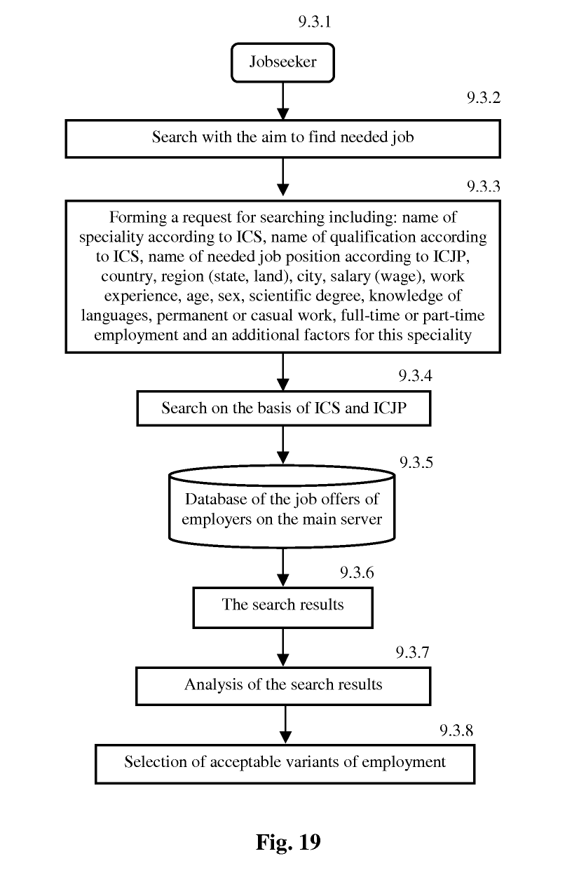

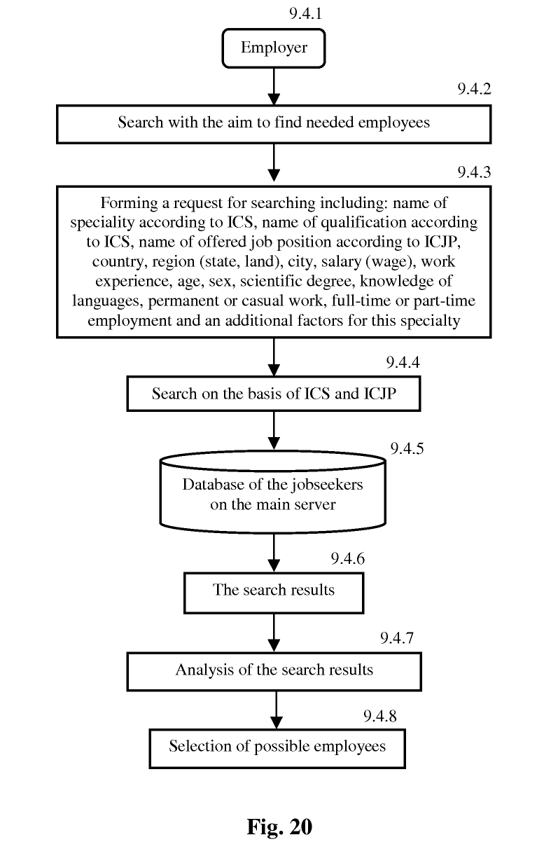

Users can execute search on the basis of an expanded request (FIG. 19, FIG. 20). For such a search for a needed job a jobseeker must specify in the application form all the desirable data (9.3.3): the name of a speciality according to ICS, the name of qualification according to ICS, the name of the needed job position according to ICJP, a country, a region (state, land), a city, a salary (wage), a work experience, age, sex, a scientific degree, knowledge of languages, a permanent or a casual work, full-time or part-time.

Searching is executed in the database of the job offers (9.3.5) on the basis of International Classification of Specialities (ICS) and International Classification of Job Positions (ICJP) (9.3.4). Upon completion of the search the system provides a list of acceptable vacancies (9.3.6) or informs that there are no acceptable variants of employment found.

The jobseeker can change initial data (9.3.3) for search and repeat the search. The jobseeker is also allowed to specify only a part of initial data for searching. For example, if he/she does not specify a desirable salary (wage), then he/she will get a longer list of available vacancies because there is no limitation on a salary (wage). If the jobseeker does not specify a desirable job position, then he/she will get again a longer list of vacancies with all the offered job positions and so on.

The search on the basis of an expanded request can be carried out in the specified time by jobseeker and be repeated a specified number of times.

For a search on the basis of an expanded request of needed employees an employer must specify all the desirable data in the application form (9.4.3): a name of a speciality according to ICS, a name of qualification according to ICS, a name of an offered job position according to ICJP, a country, a region (state, land), a city, a salary (wage), a work experience, age, sex, a scientific degree, knowledge of languages, a permanent or a casual work, full-time or part-time employment.

Searching is executed in the database of the jobseekers (9.4.5) on the basis of International Classification of Specialities (ICS) and International Classification of Job Positions (ICJP) (9.4.4). Upon completion of the search the system provides a list of offers from jobseekers (9.4.6) or informs that no jobseekers fitting the requirements are found.

The employer can change the initial data (9.4.3) for the search and repeat it. The employer can also specify only a part of initial data for searching.

The search on the basis of expanded request can be carried out in the specified time by the employer and is repeated a specified number of times.

FIG. 21 describes the transaction block. Upon definition of potential partners in the system of global job market, users can engage into negotiations on a possible conclusion of job contracts. They can negotiate on-line using provided audio or video services or internal e-mail of the system. Audio or video can be conducted through a special window in the system. Negotiations can be conducted as an exchange of text or e-mail messages, or via telephone (11.3). If the result of negotiations is successful, the parties can prepare a job contract (11.9-11.11). The job contract can be concluded in the frame of the system (11.9) or outside the system (11.8). If the job contract is concluded in the frame of the system, the system records a debt to one of the partners, who will be named in the contract as the payer of the fee to the system.

FIG. 22 describes a process of preparing and concluding the job contract. The employer and the jobseeker, which decide to conclude a job contract in the frame of system of global job market, are able to choose a suitable type of the contract (11.10.1). The system proposes different kinds of standard job contracts. Standard job contracts differ depending on: who will sign a contract on the employer side, speciality of the employee, period of employment (for a time or permanent) and so on. The standard job contracts are prepared according to the International legal regulations. The standard job contracts include the main requisites (11.10.3), which are needed to be inscribed in the contract. The contract will not be registered in the system until these data is inscribed. The system automatically inserts the main data about the employer and the employee in the contract form (11.10.2). After that the partners can introduce additional paragraphs into the contract, if they wish so (11.10.4). The system provides free recommendations of lawyers of the system about additional paragraphs of a job contract. Then the partners have to decide who will pay the fee to the system, and mention that in the contract. After that the partners insert electronic signature into the contract through entering corresponding codes in the special fields (11.10.5). The partner having a seal according to the article of associations must input the seal code in the determined place. After that the system verifies the introduced signature and seal codes (11.10.6). If all the data is valid, the system places scanned signatures and seals of each party into the determined places in the contract. After that the system registers the contract, assigns the number to the contract and records the contract into the database (11.10.7). After that the contract registration is declared valid. The both parties are granted an access to the contract (11.10.8) in order to be able to print it, store it in another location and so on.

The contract will be registered automatically only in case, if it was signed by the both parties, so none of the parties can reject the fact, that the contract was signed. This procedure increases the reliability of the contract. The system can confirm the conclusion of the contract in case of a conflict situation.

For acceleration of procedure of a choice of applicants for a vacant position, the employer can declare within the limits of system of the global electronic job market competition for vacant job position (tender). For the competition announcement about of a vacant position the employer fills the special form (the step 10.1 FIG. 23) in which he inserts the name of an offered position from the International Classification of Job Positions, the name of a speciality and qualification from the International Classification of Specialities. By means of popup menus or popup lists, the employer inserts in the form the name of the country, region and a city where there is a specified vacant position, level of the offered salary, the experience of work which the candidate on a vacant position should have, an educational level, the name of a scientific degree which the candidate on a vacant position should possess, the type of work, the data about languages which the candidate should know, desirable age of the candidate, if this has interests for him, a sex of the candidate on a vacant position, if it has for him any value.

Besides, the employer inserts in the specified form the additional requirements to the applicant for the vacant position, conditions of carrying out of competition, time of the beginning of competition, time of the termination of reception of demanded documents, the list of documents which the applicant for a vacant position should give to organizers of competition, time of the announcement of results of competition.

The organizer of the tender brings a payment for the announcement and holding the competition for vacant job position within the limits of system of a global electronic job market (the step 10.2 FIG. 23).

Then the system of the global electronic job market makes searching and selecting of possible candidates according to the data inserted by the employer in the application form about the announcement of the tender, specified above (the step 10.3 FIG. 23).

The employer (the organizer of the tender) can take advantage of the offer of system of the global electronic job market about automatic dispatch of letters to candidates for the vacant job position which list has been received as a result of search. In this case the system of the global electronic job market automatically forms the letters on the basis of data, which the employer has inserted in an application form about the announcement of the tender, and then dispatches these letters to candidates for the vacant job position (the step 10.4 FIG. 23).

The employer (the organizer of the tender) can see itself the list received as a result of search, and choose suitable candidates for participation in the tender (the step 10.5 FIG. 23). In this case the system of a global electronic job market automatically forms the letter on the basis of data which the employer has inserted in the application form about the announcement of the tender, and dispatches the letters, to the chosen candidates (the step 10.6 FIG. 23).

Candidates on a vacant position, send all necessary documents to the organizer of the tender (the step 10.7 FIG. 23).

The organizer of the tender carries out the analysis of the received documents from applicants for a vacant position, chooses the suitable candidate and declares results of competition by the publication of this result on any special page of the Web site of system of the global electronic job market, accessible only for participants of competition (the step 10.8 FIG. 23).

As a result of carrying out of the tender, the organizer and the winner of the tender conclude the contract within the limits of system of the global electronic job market (the step 10.9 FIG. 23).

Distinctive feature of carrying out of competition for a vacant job position (tender) within the limits of system of the global electronic job market is that:

a) the system of the global electronic job market forms the list of possible candidates on participation in the tender as a result of searching and selecting on the basis of the data inserted by the employer in an application form about the announcement of the tender;

b) only the candidates corresponding to request of the organizer of the tender are invited to competition, that essentially increases probability of their participation in competition, in comparison with the usual announcement of competition, for example in the newspaper or on a company site;

c) automatic formation of the letter for dispatch to candidates on the basis of data which the employer has inserted in an application form about the tender announcement;

d) possibility of automatic dispatch of letters to candidates for the vacant job position, which list has been received as a result of search;

e) essential acceleration of procedure of competition.

FIG. 24 describes additional services of the system of electronic job market. These services include:
a detailed help for working in the system of electronic job market with a number of examples (12.1),
an juridical services dealing with problems of electronic job market (12.2),
an analysis and prognosis of the job market, if required by Companies, other organizations and individuals (12.3),
an analysis and prognosis of specific branches of the job market (12.4),
a publication of the magazine with an analysis of the global electronic job market (12.4), and
“Hot-line” with consultation about the work of the system of electronic job market (12.5).

What is claimed is:

1. A system of global electronic job market in the Internet for users, including jobseekers and employers as equitable job market participants, comprising at least a host server connected with the Internet, computers of the users, capable to contact by means of the Internet with the host server, where the host server includes a Web site and a database and where the said database at least comprises:
a) a group of related data tables representing the International Classification of Specialities;
b) a group of related data tables representing the International Classification of Job Positions;
c) a database containing the information about jobseekers, which represents group of the related tables of data, where the group of fields, in which the information about the specialities is contained, represents foreign keys, related with primary keys of all tables of the International Classification of Specialities, and where the group of fields, in which the information about the job positions is contained, represents foreign keys, related with primary keys of all tables of the International Classification of Job Positions;
d) a database containing the information about offers of employers, which represents group of the related tables of data, where the group of fields, in which the information about the specialities is contained, represents foreign keys, related with primary keys of all tables of the International Classification of Specialities, and where the group of fields, in which the information about the job positions is contained, represents foreign keys, related with primary keys of all tables of the International Classification of Job Positions.

2. A method of operation of system of global electronic job market for jobseekers and employers in the Internet, comprising the combination at least of following steps:
a) forming the database of the information about jobseekers on the basis of a data provided by themselves, where a name of his speciality and qualification the jobseeker specifies according to the International Classification of Specialities and where a name of desired job position the jobseeker specifies according to the International Classification of Job Positions and where the size and the format of part of other data are strictly defined and where all said data represent the related information with the database of the host server;
b) forming the database of offers of employers on the basis of a data provided by themselves, where a name of proposed job position the employer specifies according to the International Classification of Job Positions and where a name of required speciality and qualification for said job position the employer specifies according to the International Classification of Specialities and where the size and the format of part of other data are strictly defined and where all said data represent the related information with a database of the host server;
c) forming a request for searching of an information about job vacancies by jobseeker, where a name of his speciality and qualification in a form of request the jobseeker specifies according to the International Classification of Specialities and where the jobseeker specifies a name of desired job position in a form of request according to the International Classification of Job Positions;
d) forming a request for searching of an information about pretenders for job vacancies by employer, where a name of proposed job position in a form of request the employer specifies according to the International Classification of Job Positions and where the employer specifies a name of required speciality and qualification for said job position in a form of request according to the International Classification of Specialities;
e) searching job vacancies according to a request of a jobseeker and selection of the corresponding information from the database of offers of employers, when the code of a speciality in request of the jobseeker and the code of speciality in the database of offers of employers represent the related information on the basis of the International Classification of Specialities and when the code of job position in request of the jobseeker and the code of job position in the database of offers of employers represent the related information on the basis of the International Classification of Job Positions;
f) forming a file of results of search on the basis of a request of a jobseeker, the structure of which completely corresponds to the structure of the database of offers of employers and which completely corresponds to request of the jobseeker;
g) searching pretenders for job vacancies according to a request of a employer and selection of the corresponding information from the database of jobseekers, when the code of a speciality in request of the employer and code of speciality in the database of jobseekers represent the related information on the basis of the International Classification of Specialities and when the code of job position in request of the employer and code of job position in the database of jobseekers represent the related information on the basis of the International Classification of Job Positions;
h) forming a file of results of search on the basis of a request of a employer, the structure of which completely corresponds to the structure of the database of information about jobseekers and which completely corresponds to request of the employer;
i) sorting and selecting of data from a file of results of search;
j) holding a competition for vacant job position (tender).

3. The method according to claim 2, where selecting of data from a file of results of search comprises a combination of steps:
a) an activation of demanded criteria of selecting from the list of criteria;
b) a choice of the name or size of criterion of selecting from a database of the host server where codes of criteria of selecting and corresponding data of the file of results of search represent the data having identical structure;
c) definition of a priority of criterion of selecting;
d) selecting of data from the file of results of search on the basis of the criteria defined by the user and forming the new list of results.

4. The method according to claim 2, wherein holding a competition for vacant job position (tender) by an employer, comprises at least a combination of steps:
a) filling the application form for an announcement of the tender, where the employer at least declares which vacant job position he offers in accordance with the International Classification of Job Positions and what speciality in accordance with the International Classification of Specialities corresponds to said job position, declares additional requirements for the vacant job position, the level of salary, starting time of the tender, time of the announcement of results of the tender;
b) searching of potential participants of tender in accordance with the application form for an announcement of the tender from the database of jobseekers as stated in claim 2, item g), and forming the list of potential participants of the tender;
c) notification of potential participants about the tender which is carried out or by automatic sending messages about the tender to all potential participants on the basis of list of found potential participants, or by sending of messages to the potential participants chosen by the organizer of the tender from the list of potential participants;
d) declaration of a result of the tender by means of publishing this result on any special page of the system of global electronic job market exclusively available for the participants of the tender; and
e) conclusion of the contract in the frame of the system of global electronic job market between the organizer and the winner of the tender.
